(19) United States
(12) Patent Application Publication
(10) Pub. No.: US 2017/0123709 A1
(43) Pub. Date: May 4, 2017

(54) SYSTEM AND METHOD FOR CONSOLIDATING AND PERFORMING DATA MANAGEMENT FOR A PERSONAL COMPUTING DEVICE

(71) Applicant: The Dolphin Project Inc., Calgary (CA)

(72) Inventor: Shaffiq Kotadia, Calgary (CA)

(21) Appl. No.: 15/337,760

(22) Filed: Oct. 28, 2016

Related U.S. Application Data
(60) Provisional application No. 62/248,272, filed on Oct. 29, 2015.

(51) Int. Cl. G06F 3/06

(52) U.S. Cl. CPC G06F 3/0638; G06F 3/0604; G06F 3/0647; G06F 3/067

(57) ABSTRACT

There is provided a system and method to consolidate data and perform data management of a personal computing device. The system and method enables the storage capacity of a personal computing device by allowing access and/or data migration to a secondary storage device.

### CROSS-REFERENCE TO RELATED APPLICATIONS

This application claims the benefit and priority of U.S. Provisional Application 62/248,272, filed Oct. 29, 2015. The foregoing application is incorporated by reference herein in its entirety

### FIELD OF THE INVENTION

The present invention pertains to the field of data management and storage. In particular data management and storage for a personal computing device.

### BACKGROUND

Personal computing devices including but not limited to laptop computers, tablets, and mobile phones are commonly used for a number of different functions in everyday life. From financial planning, to photography, to communication—many activities in our daily lives are monitored and data related to those activities is created and stored on our personal computing devices.

The use of personal computing devices, personal monitoring and data collection will continue. The prevalence and development of applications and programs used on these devices will also continue—as is illustrated by the popularity of mobile “Apps”. Social media forums that collect and display text, pictures and other digital content also create and log large amounts of data that may be stored on personal computing devices. Email, texting and other forms of digital communication also accumulate vast amounts of data that can be stored on personal computing devices.

When an application creates data, such data may be stored on a personal computing device. The user of such a device is usually able to manually manage the accumulated data in relation to each individual application. They are also able to manually monitor the entire storage capacity of their computing device. The user requires significant time and effort to supervise each of the individual applications and total storage capacity in order to ensure that the application or personal computing device does not reach its full storage potential. Storage capacity of a personal computing device can fill up very quickly, and once it reaches upper thresholds of capacity, the processing capability and functionality of the personal computing device may be limited.

Secondary storage devices such as but not limited to cloud computing, external hard drives, and USB sticks have been developed in part to relieve the limitation of storage capacity of personal computing devices. The user can decide to transfer portions or the entirety of the data stored within each application to a secondary storage device. Often, the user is required to manage data storage of each application individually which takes significant time and effort to achieve.

Secondary storage devices have limited capacity. The amount of data that can be stored by a user on a single secondary storage device is limited to the capacity of that particular device. Personal computing devices often have limited storage capacity and the user may have to purchase a secondary storage device(s) in order to store the data created. Purchasing a secondary storage device to compliment a personal computing device is expensive.

Secondary storage devices also provide a means to backup user data. By saving the data in multiple spaces, a user is able to access a secondary data set when a primary data set is lost. In this way they are able to backup data from a personal computing device and recover it. The user is required to manage the primary and backup data manually which takes significant time and effort to achieve.

Therefore there is a need for a system and method for data management of a personal computing device that is not subject to one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of the present invention is to provide a system and method that consolidates data and performs data management for a personal computing device. In accordance with an aspect of the present disclosure, there is provided a system and method that monitors the storage use of a personal computing device and extends the storage to a secondary storage device.

In accordance with another aspect of the present invention, there is provided a system and method which replaces the data storage and management aspects of multiple applications with a single data management application. This single application will consolidate the data storage and management functions of multiple applications into one application in order to reduce the requirements of data retention resources of a personal computing device. Such a system and method will also significantly reduce the time and effort required by a user of a personal computing device to manage data created by and stored in their device.

In accordance with another aspect of the present invention, there is provided a system and method which is able to utilize numerous secondary storage devices to create an alternative storage platform including an accumulation of storage capacity formed by each of the secondary storage devices. Such storage capacity may free up personal computing device resources for improved functionality.

In accordance with another aspect of the present invention, there is provided a system and method that is capable of synchronizing data management and storage across multiple personal computing devices, by accessing the same, or a mirrored consolidated data set. This also results in the protection of the consolidated data in the ability to externally backup and store such data for recovery at a later time.

### BRIEF DESCRIPTION OF THE FIGURES

Embodiments of the present invention will be better understood in connection with the following Figures, in which:

FIG. 1 illustrates a schematic representation of the system synchronization method.

FIG. 2 illustrates a schematic representation of the general process flow of the system.

FIG. 3 illustrates a schematic representation of the forward process flow for resource management.

FIG. 4 illustrates a schematic representation of the reverse process flow for resource management.

FIG. 5 illustrates a schematic representation of the disaster recovery process.

FIG. 6 illustrates a schematic representation of the secondary storage device stitching process.

FIG. 7 illustrates a schematic representation of the data backup process.

### DETAILED DESCRIPTION

### Definitions

The term “personal computing device”, hereinafter also referred to as a “PCD”, is used to define a digital device that is used to create, collect or store information or data and may include, but is not limited to desktop computers, laptop computers, digital personal assistants, mobile phones, tablets, and the like.

The term “secondary storage”, hereinafter also referred to as an “SS”, is used to define additional storage capable of storing digital information or data and may include, but is not limited to external hard drives, USB keys, cloud computing, and the like. The term “SSD” refers to a secondary storage device.

The term “user” is used to describe the person or persons who are using a personal computing device.

The term “data” is used to describe information used, created, or stored within a personal computing device, and may include but is not limited to any directory, object, application, icon, video, picture, text information, music, documents, or other information understood by someone skilled in the art.

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this invention belongs.

### System and Method Overview

The present system and method provides the ability to consolidate data and perform data management for an application, program or the like that is used by a PCD. Embodiments also provide the ability to extend the storage capacity of the personal computing device by allowing access and/or data migration to SS. The access and/or migration can be automated according to predetermined user preferences, such preferences capable of alteration. It is contemplated that SS may be formed by stitching together a plurality of SSD's to form a storage array, further extending the storage capacity of the PCD. The storage array can provide greater information and data protection by creating a backup version and ability to encrypt that information. Such data can also be recoverable to a PCD. It is further contemplated that multiple PCD's may be integrated together in the same way that a storage array is formed, allowing for transfer of data and information between the PCD array and the SSD array. Finally, some embodiments may store the entirety of the data object of an application used by a personal computing device, while leaving a link representing that application on the PCD. This link can be viewed and accessed by the user in order to recall the data object of that application from the SS.

The system as contemplated consists of a user interface, interface module and management module. It provides a high level of interaction and integration between these components to perform a number of different tasks automatically and/or manually depending on the PCD user preference.

### User Interface

In one embodiment of the system and method, there is a user interface component that allows the user to make selections regarding how data on the PCD can be managed. These selections can allow the user to define which PCD data is managed by the disclosure. These selections may be stored and used for successive data management updates.

In another embodiment of the system and method, the user interface can provide default data management settings. Default settings may be accepted or changed by the user according to the user's preferences. Default settings can remain and apply to data resource management until such time as the settings are altered by the user.

According to embodiments, the user is able to select which PCD will be associated with data consolidation and resources management. The user may select a single, multiple, or combinations of PCDs to associate with the data migration and management performed by the system and method. For example a user may configure a smart phone, tablet, and desktop computer to be able to access the same data objects.

According to other embodiments, the user is able to select which SSD will be associated with data consolidation and resource management. The user may select a single, multiple, or any combination thereof, of SSDs to associate with the data migration and management performed by the invention.

In an embodiment of the system and method, the multiple SSDs can be integrated together to form an array of SSDs. This array may then act as larger SS in order to provide greater storage capacity to the PCD. In some embodiments, such an array provides redundancy against the failure of any SSD.

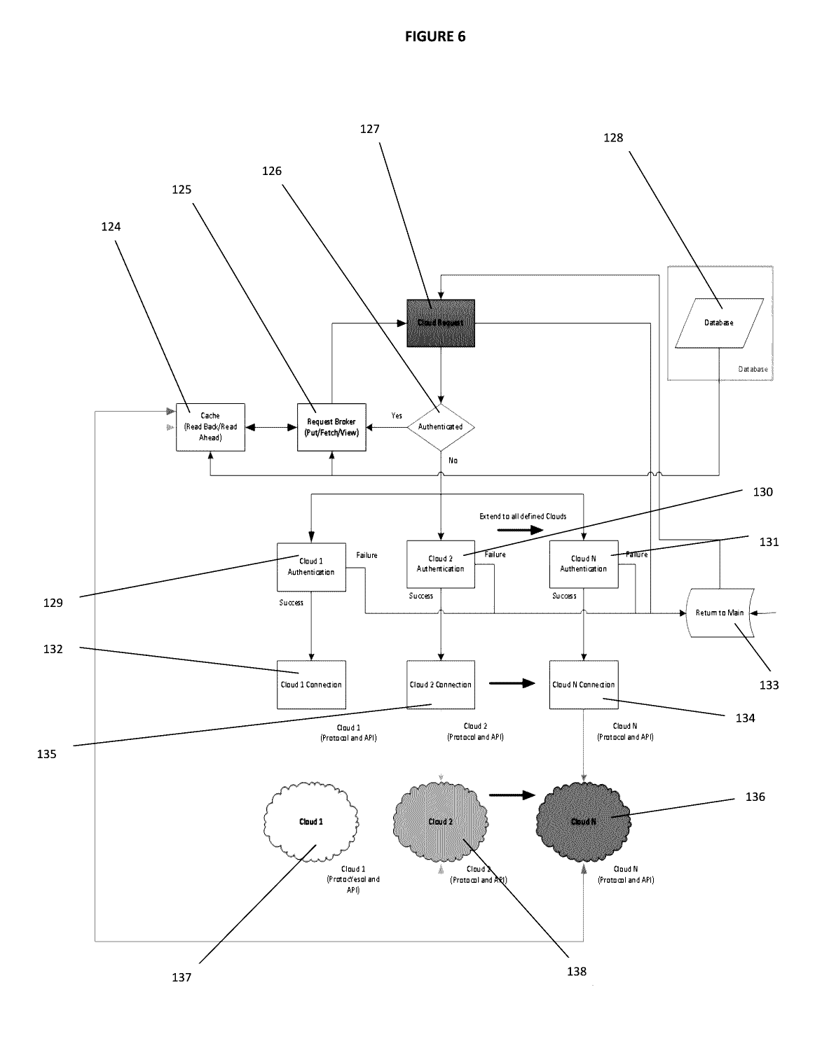

According to embodiments, the SSD array includes multiple cloud storage devices. There are many cloud storage providers that offer various services for free. A sequence of events that may take place when a request is issued to submit or retrieve a data object from the cloud SS is described in FIG. 6. At the cloud request step, verification is done to see if cloud storage has been defined and is accessible. If it is not accessible or defined, then a request is made to the user to identify and define cloud storage spaces. If the request is successful, the cloud spaces are defined and brought online for the data management application. For each cloud service provider, the respective Application Programming Interface (hereafter also referred to as “API”), and protocols are established. At the cloud request stage, if the cloud storage spaces have already been defined and an authentication step is successful, then the request is forwarded to the request broker that analyzes the request and forwards it to the cache. The cache stores information regarding where a data object, which defines the specific data to be stored, resides in the cloud and the state it is in, as encrypted or unencrypted for example. It forwards the request to the cloud to either submit or fetch a data object as per the user request and send it to the request broker to respond to the cloud request section. The cache also forwards the request to the appropriate cloud service provider using their respective APIs and protocols.

According to embodiments, user will have the capability to temporarily or permanently delete, alter, or download the entirety or portions of the data that has been selected for migration. The user may request the use of previously migrated data, at which point the material will be retrieved from the predefined SS. In this way any migrated data may be backed-up and saved as a master copy. The user at their discretion, through the API as described above, will be able to view the remote directories located in SSDs. In this way the user will be able to manually monitor, organize and manage data on their PCDs and the SS.

The user may select the mechanism of data migration from the PCD to the SS. This mechanism may be any of, but is not limited to use of a hardwire connection, WiFi wireless connection or wireless network connection. The user may select an acceptable time frame for data transfer between the PCD and SS. This user-selected time frame may be used to set thresholds that will be capable of data manipulation including, but not limited to preventing or initiating data migration.

According to embodiments, the user can select other specific migration thresholds such as, but not limited to CPU, memory and network usage thresholds. The user will also be able to specify a fixed maximum or minimum threshold in relation to the number of retries for data migration. The user will further be able to specify a time interval between retries of data migration. All of these user-selected thresholds will be capable of manipulating data transfer including, but not limited to preventing or initialing data migration.

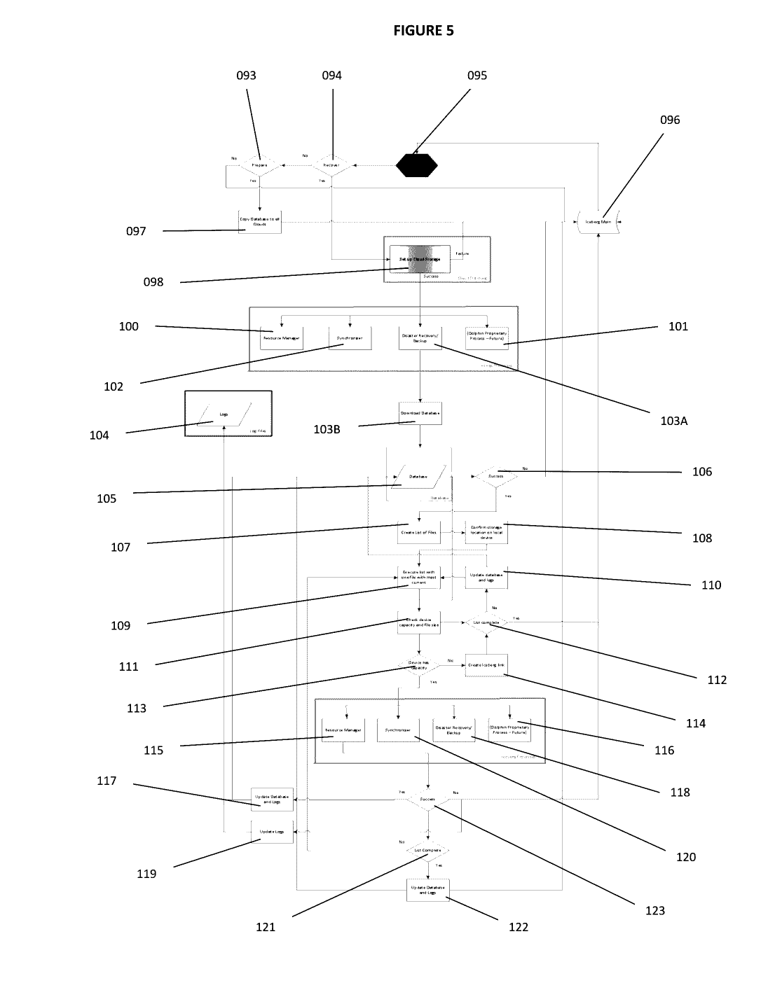

In another embodiment, the user will be able to select certain security features to protect data prior to migration. In one example, the user may choose to encrypt the data prior to migration. If such a selection is made, the data may be migrated and stored in the SS in an encrypted form. In FIG. 5, the application process section manages the retrieval of data with or without encryption.

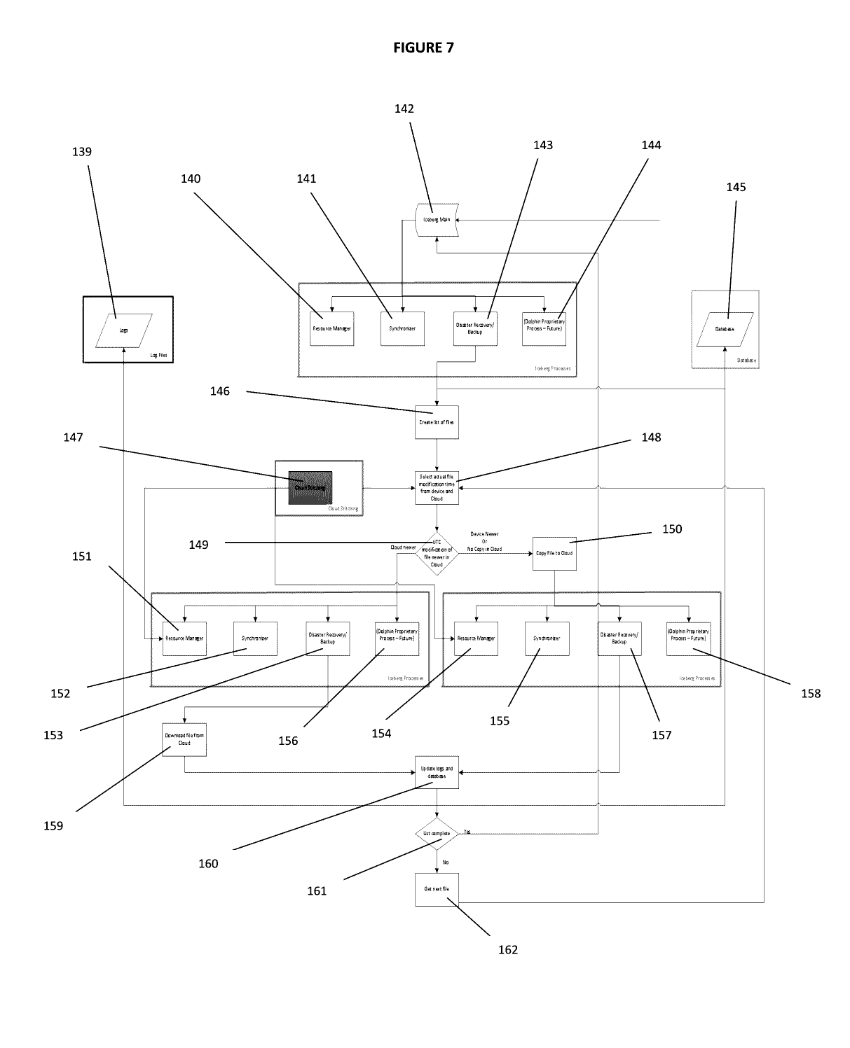

According to embodiments, once data migration has been completed between the PCD and the SSD, the SSD may act to preserve a second or master copy of the data. In this way the migrated data from the PCD may be backed-up and the system and method may act to prevent the permanent loss of data (FIG. 7). This process ensures that in the event of a PCD failure, and/or the loss of user data, the data migration application can retrieve all the data from the SSD and ensure that no user data is lost.

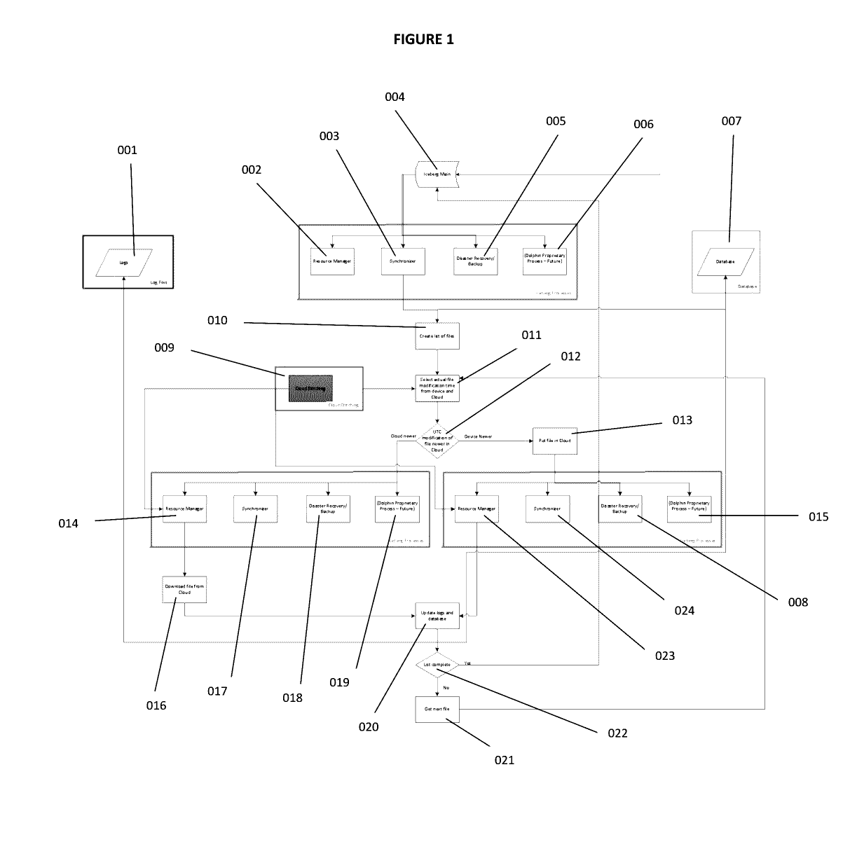

In one embodiment, the backup process may use the synchronization module which synchronizes the data across PCDs and the SSDs, and cloud stitching module which integrates multiple SSDs to form a conglomerate of storage space, to analyze the user selected data, and if a file has not been virtualized, copy it to the SSD. While the backup process flow as described in FIG. 7 is similar to the synchronization process flow in FIG. 1, for the data backup process the application monitors the data objects, and determines if data is newer on the PCD, or does not exist on the secondary SSD. If the data object is found to be such an object, then it is copied to the SSD.

In another embodiment of the system and method, in the event of a complete PCD failure or data loss (disaster event), the user may select the option to install the data management application as a disaster recovery mode installation. Upon installing the data management application in this mode, user data can be recovered onto a new PCD. The data management application may ask for an initialization of a SSD, such as the cloud services, through user authentication. The cloud stitching module will then bring associated SSDs online. Once this is accomplished, the data management application will attempt to retrieve the data management application database that stores data, and information about the data on the SSDs and the PCDs. Upon a successful retrieval of the data management application database, the data management application will further analyze the database and tabulate the most recently modified and most recently accessed data under user management. The list of data will be executed and the data management application will download the files as per the criteria noted above. It should be appreciated that a process is not limited to disaster recovery. A similar process can be used if a user wants to transfer data to a new device, for example in the case of a device upgrade.

In another embodiment, if the personal computing device begins running out of resources during the data retrieval, such as during a disaster event as described above, the files will be installed on the PCD as application links. This mechanism enables the recovery of data on a PCD which may have smaller capacity than the one on which the data management application was originally installed. A data management application database is critical in this scheme—a copy of the database may be created on each of the SSDs.

The user may also be prompted to confirm specific permanent actions they decide to perform in relation to the data or data migration. For example, if a user selects a data object to be permanently deleted, the user interface will require the user to confirm that the data object should be deleted on the PCD, the SSD, or on both devices prior to completing the deletion.

During data migration, it is considered that the system and method may not complete the entirety of the migration due to threshold settings, an unforeseen event or some other reason that prevents the completion. Embodiments will keep track of such an incomplete migration event and tag that event as such. The user may select, or default settings may dictate how such a tagged incomplete migration will be treated. In one example the incomplete data migration may automatically restart upon a threshold value (such as entering a WiFi zone that allows for sufficient communication bandwidth required for data transfer) being achieved.

According to embodiments, the user interface will provide a communication mechanism that describes aspects of the data migration to the user. This user interface can provide information relating to, but not limited to the success or failure of the migration; status of the PCDs and SSDs; threshold limits; security status; storage capacity; user selections; data migration history; location and status of data on the PCDs and SSDs; as well as other details.

According to embodiments, the user interface as described above will provide the user with the option to alter data migration selections. The user will be able to monitor and alter these selections on an ongoing basis. Such new selections will be implemented immediately and will remain in force until such time as the user redefines the selections through the communication mechanism. It is also contemplated that the user may implement, alter and restore default settings saved within the user interface at any time.

It is understood by those skilled in the art, that the provided embodiments as defined above are examples of how data resource management can be achieved using a invention capable of managing and consolidating data, which is manipulated by a user. The embodiments are not intended to be a complete listing of the available data resource management options that a user may choose from.

### Interface Module

According to embodiments of the system and method, there is an interface module that creates a virtual platform to facilitate interaction between the user interface and the management module. The interface module will have the capability to disassociate an application's user interface from the data used within and/or created by that application. When disassociation is performed, the user interface will allow the user to view the user interface of an application, while management software will concurrently migrate that application data from the PCD to the SSD.

According to embodiments, the interface module will associate an application icon independently of a data object. In this way the data object will be available for migration from the PCD to the SSD without having to migrate the application icon. It is also contemplated that the module will alternatively facilitate a re-association between the data object and the application icon if a disassociation has occurred. In this way the user will be able to manipulate an application alternating between an original fully associated application, and one that has dissociated an application icon from a data object.

According to embodiments, the interface module will monitor the status of each application used within a PCD. It will provide a means to inform the user about if an application is in an associated or disassociated state on their PCD. If the application is identified as being in a disassociated state, the user will be provided with additional information about the retrieval process from the SSD such as but not limited to time required to retrieve, amount of data that needs to be migrated, or any other information as would be contemplated by someone skilled in the art.

### Management Module

According to embodiments of the system and method, a management module is configured to perform several functions, including but not limited to those related to data migration between the PCD and SSD. Each function may be altered by the PCD user depending upon the user's specific needs. Alternatively, the functions may be in accordance with default settings as initially defined by the data management application. Functions will include those functions that are discussed such as but not limited to synchronization, data transfer, SSD stitching and the like.

According to embodiments, the tasks that the management module can perform includes, but is not limited to an initial scan of the PCD in accordance with the user defined data migration selections, or according to default PCD initial scan settings. The initial scan can provide information regarding one or more applications or data located on the PCD. A secondary PCD scan, or update scan, may be performed according to a user-set or default schedule, in order to identify any new application or data or the like, that has been marked for migration to a SSD.

It is also understood that when the system and method is initially activated, it will perform a scan of previous and existing users. When such an existing user is identified to be the same user to have just activated the management module, the management module will recognize that user. When provided with proper identification credentials, the management module will allow access to an existing SSD which may or may not contain previously migrated data.

According to embodiments, after a PCD has been scanned as is discussed above, the management module will create a catalogue of data that has been selected for migration. This catalogue will preserve the relative data directory structure and names as are revealed during an initial, or update scan. The catalogue will keep information related to the data including, but not limited to the name of the data object, the location of the data on the local PCD, the last recorded access time of the data, the remote migration directory in the SSD, the time required for migration, the success/failure of the migration, the number of copies of each data object, the data migration transfer percentage of the data object, and other data information as is understood by someone skilled in the art.

According to embodiments, the management module will be capable of performing an inspection on the capabilities of a PCD and/or a SSD. It is understood that the inspection will provide information that can be used in a variety of ways including, but not limited to defining and monitoring boundaries or thresholds related to storage capacity, power usage, and other such factors as would be readily understood by someone skilled in the art. Such inspections will be performed according to a user-set or default schedule, or threshold in order to identify updated PCD and/or SSD capabilities.

According to embodiments, the management module is configured to perform an inspection scan on other components of the system for the same purposes as outlined. Such components include, but are not limited to a wireless network, a WiFi network, hardware capabilities, and other components as would be readily understood by someone skilled in the art.

It is understood that the data management and consolidation application will be able to perform data migration dependent upon one, multiple, or a combination thereof factors, such as but not limited to the PCD or SSD storage capacity. The user may select manually, or may use default settings for a PCD or SSD storage threshold which allows for data migration manipulation. In one embodiment, when the PCD capacity threshold is met, data migration will cease prior to completion in order to prevent a PCD from reaching storage capacity. In another embodiment, when the SSD capacity threshold is met, data migration will cease prior to completion in order to prevent a SSD from reaching storage capacity.

According to embodiments, a PCD capacity threshold may be used to initiate use of the data management and consolidation application as described. In one embodiment, the user will select, or may use default settings to determine a PCD capacity threshold. Once the internal storage capacity of the PCD reaches that defined threshold, the system and method will be activated. If no such internal PCD storage capacity threshold is met, the system and method will remain dormant and will impose a minimal resource footprint on the PCD.

In another embodiment of the present invention, the PCD user is able to specify transfer factors that affect data migration. The user may specify a threshold that defines a maximum or minimum number of transfer attempts required for a data migration. Once the threshold is met, the migration may be altered in some way such as, but not limited to abandonment or delay. A user may also specify a threshold that defines a maximum or minimum time limit required for a data transfer. Once the threshold is met, the migration may be altered in some way such as, but not limited to abandonment or delay. In the event of a data migration failure, the user may also select a wait time before another data migration attempt is made. The user may also select a PCD/SSD battery level threshold that is required for data migration. If a PCD/SSD does not meet the selected battery level the migration will be altered in some way such as, but not limited to abandonment or delay.

According to embodiments, the management module will monitor data migration throughout the transfer process. During data migration monitoring, it is contemplated that the management module will compare predetermined thresholds against the ongoing progression of the migration. The data migration may be altered in some way such as, but not limited to abandonment or delay, if any of the thresholds are met during the data migration. During a data migration, the data management and consolidation application may be able to monitor a number of migration factors such as, but not limited to data migration time, data migration completion amount, PCD and SSD capacity, and the number of data migration attempts.

According to embodiments, the management module may perform a verification action prior to the completion of data migration. An example is a checksum action which consists of
i. performing an analysis of the data object at the PCD source that quantifies and defines the contents of each data object that is part of a data migration;
ii. creating a copy of each data object at the PCD source that is part of the data migration;
iii. performing an analysis of the same data object at the SSD source that quantifies and defines the contents of each data object that is part of the data migration in the same way that the data object was quantified and defined during the PCD source analysis; and
iv. comparing the PCD source analysis with the SSD source analysis.

The same checksum action as described above can be implemented when data is migrated from the SSD to the PCD. The checksum action in the reverse data migration consists of
i. performing an analysis of the data object at the SSD source that quantifies and defines the contents of each data object that is part of a data migration;
ii. creating a copy of each data object at the SSD source that is part of the data migration;
iii. performing an analysis of the same data object at the PCD source that quantifies and defines the contents of each data object that is part of the data migration in the same way that the data object was quantified and defined during the SSD source analysis; and
iv. comparing the SSD source analysis with the PCD source analysis.

According to embodiments, the management module may perform any number of actions on data and data migration in response to the checksum action as described above. The checksum action may act as a safety check to ensure the completion of the data migration prior to the migration being finalized and a data object copy being deleted. This safety check may be automatically implemented regardless of user preference. It may also be implemented dependent upon user selections. In this way the management module can avoid the loss of any data during the data migration process between the PCD and the SSD.

In one embodiment, the checksum action will prompt the management module to refrain from deleting a data object copy located on the PCD/SSD and tagged for data migration, until such time as the checksum action has taken place, and the same data object has been confirmed migrated to the PCD/SSD. In this way, mid-transfer failure events that could result in a loss of data are avoided. When such a mid-transfer failure event is detected, the data object on the PCD/SSD will be restored to the original data object using the data object copy, in preparation for a second attempt data migration.

As described above, according to embodiments a transfer threshold may be met due to data migration events as monitored by the checksum action. In one example, this threshold will trigger a data migration failure. The data management and consolidation application may confirm a data migration failure with the user and mark the transfer as such.

In another embodiment, the checksum action will confirm that the data migration was successfully completed. During such a successful data migration event, the invention will confirm the successful migration with the user and mark the transfer as such. The data object copy may also be deleted after a successful data migration, in order to reduce capacity footprint on the PCD/SSD.

In other embodiments, the management software will perform checks on the PCD/SSD data to determine if the data object being considered for migration has already been migrated. If the data object is found to have been previously migrated, the management module will inform the user and may remove the data object from the data migration process.

According to embodiments, the management software will provide notice to the user regarding but not limited to success or failure of the migration; status of the PCDs and SSDs; threshold limits; security status; storage capacity; user selections; data migration history; location and status of data on the PCDs and SSDs; as well as other details.

In another embodiment, the user may decide to remove the data management application from their PCD. When the data management application is deleted, a database of migrated data is retained within the SSD. Continued access to the SSD may be provided to the user if certain conditions are met. These conditions may include any of, but are not limited to proof of identity or payment of a fee.

In embodiments of FIG. 1, the data management application ensures that the newest version of the file on the personal computing device(s) or the secondary storage space is retained as the main version of the file. During the virtualization process if the secondary storage device version of the file is newer than the version on the personal computing device, then a link is created and the actual file will not be migrated. This check is embedded in all data management application processes. However a user can also elect to update all tagged files to ensure that the secondary storage device has the latest version in order to maintain concurrency between the personal computing device and the secondary storage device. This check as described will exist within all application processes, and will also extrapolate and enable multiple devices and systems to interact with the same secondary storage device ensuring that only the newest data object remains, and an older version does not override any updated version.

In one embodiment of FIG. 1, a request enters the main data management application user interface 004, and is directed into the synchronization process 003. The request may also be directed to the resource manager 002, the data recovery/backup process 005, or another signal manipulation process understood by someone skilled in the art 006. From the synchronization process 003 the request will initiate the creation of a list of files 010 to be migrated. The request is then analyzed to determine when the actual file was modified on the PCD in comparison to the SSD 011. Once a determination is made about the more recently updated file 012 using Greenwhich Mean Time (also referred to as Universal Time Constant or UTC), the request will be sent to the SSD 013 if the more recently updated file is on the PCD. If the more recently updated file is present on the SSD, the request will be sent to the resource manager 014. Alternatively, the request could also be sent back to the synchronization process 017, the data recovery/backup process 018, or another signal manipulation process understood by someone skilled in the art 019. From the resource manager 014 the request prompts a download of the file from the SSD 016. The file log 001 and database 007 is then updated with the new file information 020 and the updated list completed 022. The signal is reverted back to the main data management application user interface 004 or the file modification analysis 011 is repeated with the next file 021. In the instance where the more recently updated file is on the PCD and the request is sent to the SSD 013, the request will then pass into the resource manager 023 before the log 001 and database 007 are updated 020 with the new file information. The request may alternatively pass into the synchronization method 024, the data recovery/backup process 008, or another signal manipulation process understood by someone skilled in the art 015. The cloud stitching process 009 can be accessed and used by the resource manager 014, 023 during the request processing.

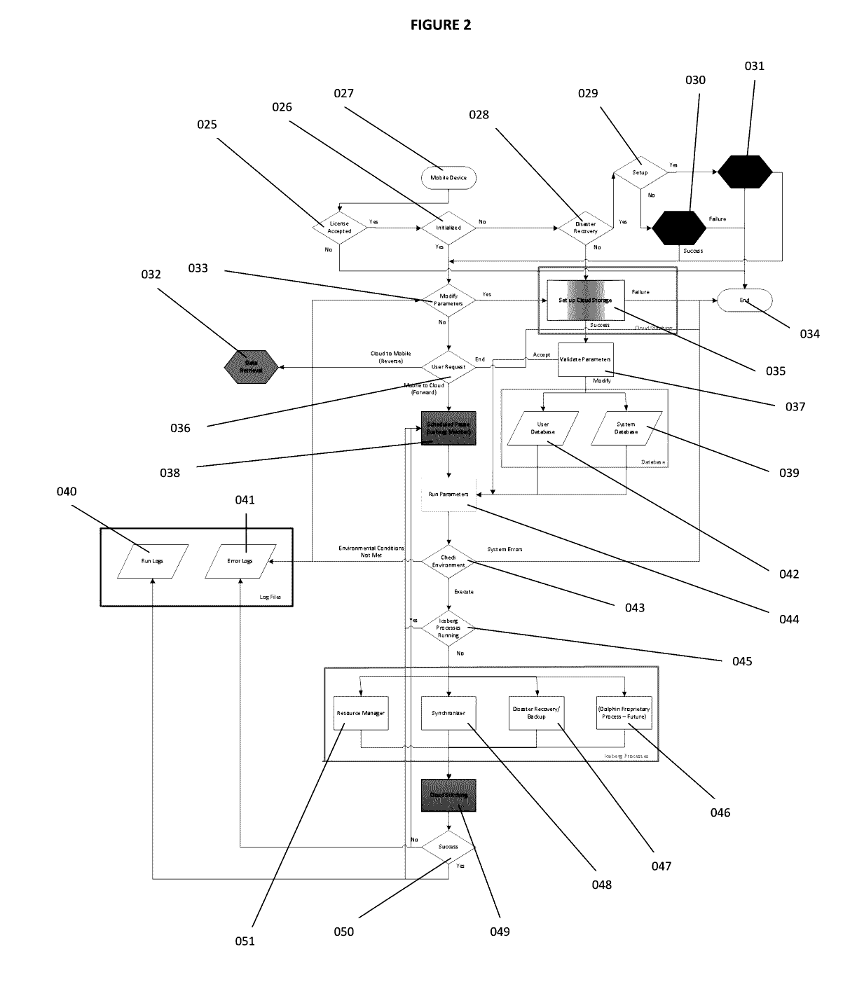

In embodiments of FIG. 2, it describes the process whereby a user first logs into the data management application. They will make initial decisions regarding critical system parameters, including but not limited to access to third party secondary storage devices. For example, the user may identify one or more cloud service providers to present and extended and contiguous cloud storage space. The user may also select various parameters that are stored in a database to ensure that data management does not affect users by overloading the personal computing device. They are able to make choices regarding the management of their data over wireless and/or WiFi networks. Users may also select default parameters that will work optimally without the need for modification. The system and method is able to manage data and protect the PCD transparently.

In one embodiment of FIG. 2, a PCD user 027 downloads the data management application and accepts the user license 025 prior to initiation 026. If the user license 025 is not accepted the process flow will end 034. After initiation 026, the user may modify the parameters of the data management application 033. If initiation 026 is not successful, the disaster recovery process will be requested 028. If it is accepted, the user will setup 029 the disaster recovery process 030 or an initialization setup 031. The initialization setup 031 will either return to the initialization step 026, or if unsuccessful, end the process flow 034. If the disaster recovery process 030 is successful, it will return to the initialization step 026; if it is unsuccessful, the process flow will end 034. Once the parameters of the process flow have been modified 033, the cloud storage setup process will begin 035. If parameters are not modified the user will be able to make requests 036 to end the process 034, transfer data from a PCD to a SSD on a predefined scheduled phase 038 and begin running parameters 044, or transfer data from an SSD to a PCD to begin data retrieval 032. If the cloud storage setup process 035 fails, the process flow will end 034. If the cloud storage setup process 035 is successful, validation of the parameters will be requested 037. If such parameters are accepted, the data management application will begin running parameters 044. If the validation of parameters 037 is not accepted, modification through the user database 042 or system database 039 will be implemented before running the parameters 044. Once the parameters begin running 044, an environment check will be implemented 043. If system errors are found during the check, the process will end 034. If environmental conditions are not met, the error will be logged 041 and the user will be directed to modify parameters again 033. If the environment conditions are met, the data management application will begin running 045. If the data management application default parameters are engaged, the process will continue through the run logs 040 and return to transferring data from a PCD to a SSD on a predefined scheduled phase 038. If the data management application is engaged with user preference settings 035, the user will be able to select if the process will flow through the resources manager 051, the synchronization process 048, the disaster recovery/backup process 047, or another signal manipulation process understood by someone skilled in the art 046. These processes can transfer data through the cloud stitching process 049. If such data transfer is successful 050, the process will run a log of the transfer 040. If the data transfer is not successful, an error is logged 041 and the process returns to the scheduled phase again 038.

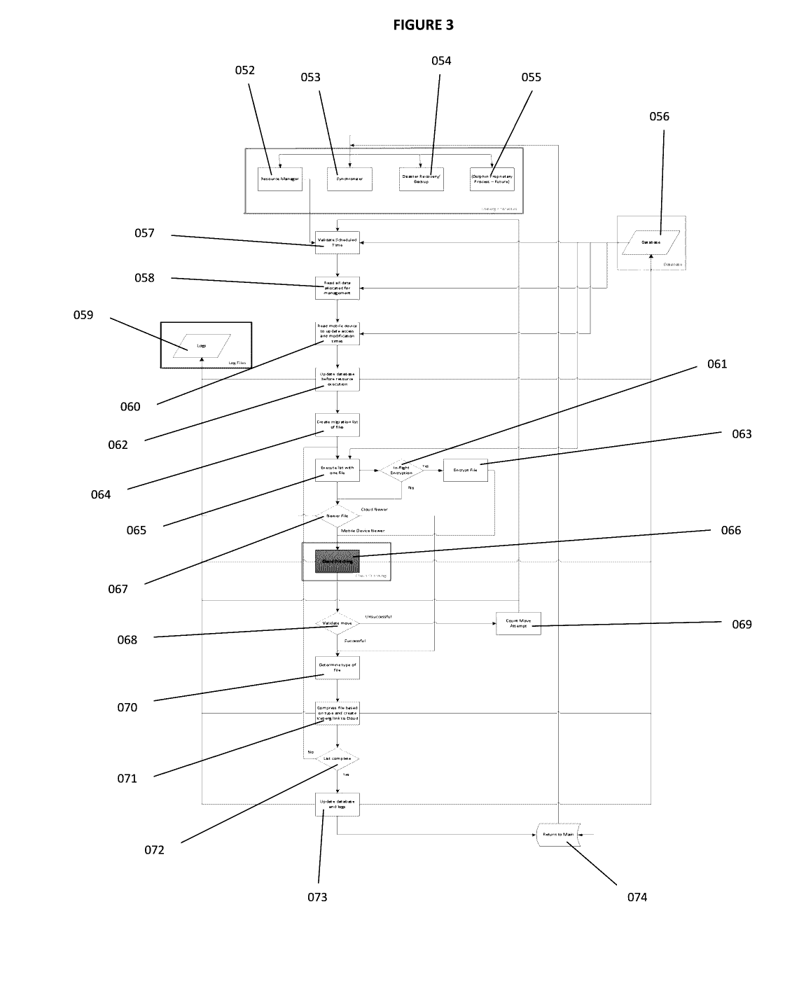

In embodiments of FIG. 3, if a user data object has not been accessed over a specified period of time then the data management application will activate and move that resource to a secondary storage device, such as cloud storage, leaving behind an icon that makes it appear as though the data remains on the device. Illustrated in this figure, a user can elect to encrypt the data so that while it is migrated it will be encrypted so that the data is protected. In another embodiment the data may be migrated through a cloud stitching module as represented in FIG. 6.

In one embodiment of FIG. 3, the main data management application user interface 074 is accessed. When the resource manager is engaged 052, instead of the synchronization process 053, disaster recovery/backup process 054, or another signal manipulation process understood by someone skilled in the art 055, there is a validation performed on the scheduled time for data transfer 057. Once validation is complete the data allocated for data management is analyzed 058, and the PCD is analyzed to update data access and modification times 060. The database 056 is updated and data is logged 059 before undertaking resource execution 062. The database 056 can be accessed and return results to the validation process 057, analysis of data allocated for management 058, analysis of a PCD 060, and execution of the migration list with one file 065. Once the database update 062 is completed, a migration list of the files is created 064. The list will then be executed with one file 065, which can undertake an encryption process 061 to become encrypted 063 during the execution. If the execution 065 finds the file to be a new file 067, it logs the result 059 and determines if the SSD version or PCD version of the file is the most recent version of the file. In the case of a file that has been encrypted 063 during the execution, the file will be in a more recent form from the PCD. When the file is in a more recent form from the PCD, it can be passed into the cloud stitching process 066, which will log the data 059 and send it to the database 056. After stitching 066, the transfer can be validated 068 as unsuccessful, and a move attempt is counted 069 prior to returning to the validation performed on the scheduled time for data transfer 057. If the transfer is validated 068 as successful, the type of file will be determined 070. In the instance where the file is determined to be more recent 067 on the SSD, the determination of the file type 070 will begin immediately. Once the file type has been determined 070, the file is compressed based on the type, and a file access link is created on the PCD to access the data on the SSD 071. The link creation action 071 is logged 059 and stored on the database 056. The list execution completion is analyzed 072, and if it is not complete, the process returns to the list execution stage 065. If the list execution is complete, there will be an update 073 of the database 056 and logs 059. The process then returns to the main data management application user interface 074.

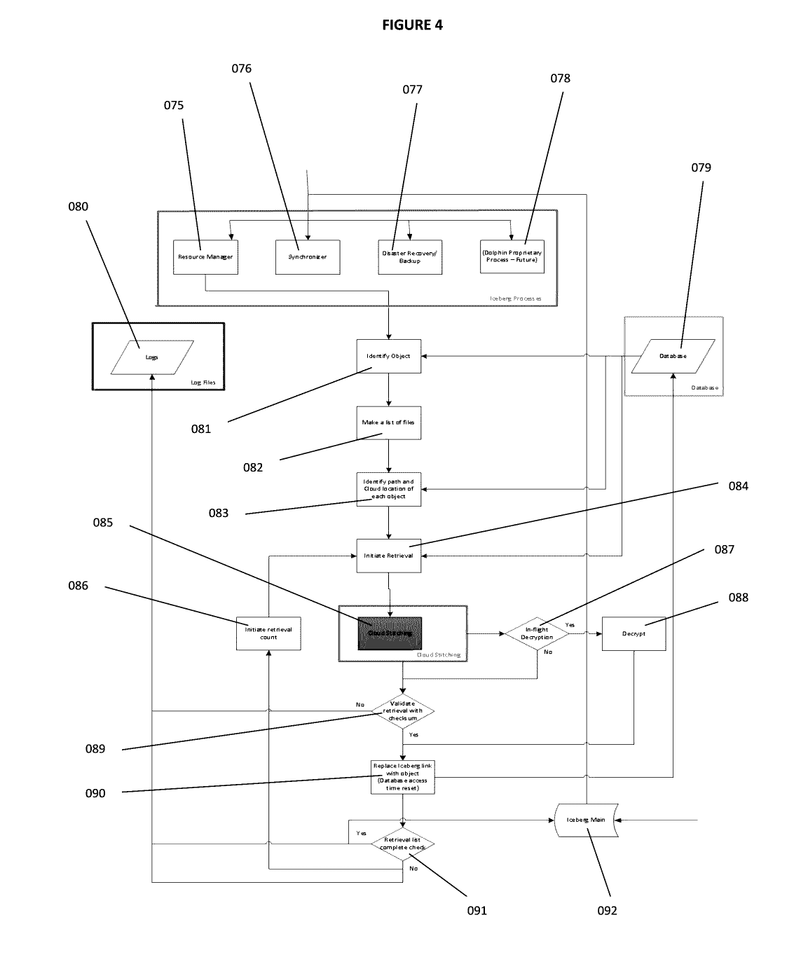

In embodiments of FIG. 4, when a user attempts to access a data object that has been virtualized, the data management application intercepts the request and forwards it to the cloud stitching module (FIG. 6) for retrieval. If the data was encrypted prior to migration to a secondary storage device, then it will be de-crypted upon retrieval and stored on the personal computing device. Users may also view which objects have been virtualized and retrieve any of them manually.

In one embodiment of FIG. 4, the main data management application user interface 092 provides access to the resource manager 075, the synchronization process 076, the disaster recovery/backup process 077, or another signal manipulation process understood by someone skilled in the art 078. When the resource manager 075 is engaged, the data object is identified 081. Once the data object is identified, a list of the transfer files is created 082 prior to making a determination of the path and SSD location of each object 083. Next the data retrieval is initiated 084, which may include access to the cloud stitching process 085. If a file is found to be encrypted, it can be decrypted 087 to become decrypt 088 prior to returning to the data object to the replace the PCD link to data stored on the SSD 090. If the file is not encrypted, after the cloud stitching process 085, a retrieval validation and check sum function will be imposed 089. If the transfer is not validated, the action is logged 080. If the transfer is validated, the data object is returned to the replace the PCD link to data stored on the SSD 090. The link replacement action 090 accesses the database 079, which provides information during the object identification 081, path identification and SSD location 083, and data retrieval initiation 084. After the link has been replaced with the data object 090, a check is performed to make sure that the list file retrieval is complete 091. If the completion is not confirmed, the action is logged 080 and a retrieval count is initiated 086 prior to returning to the file retrieval initiation process 084. If the completion is confirmed, the action is logged 080 and the process returns to the main data management application user interface 092.

In embodiments of FIG. 5, the user may select the option to install the data management application in a disaster recovery mode installation. In the event of a complete personal computing device failure or data loss, all user data can be recovered onto a new personal computing device upon installing the data management application in this mode.

In one embodiment of FIG. 5, the main data management application user interface 096 provides access to the disaster recovery process 095. Data recovery 094 may not be desired, and recovery preparation can be requested 093. If data preparation is not requested, the user will be directed back to the main data management application user interface 096. If data preparation is requested, the database will be copied to all SSDs 097, and the user will be directed back to the main data management application user interface 096. When data recovery 094 is required, the request may access the cloud stitching process 098. If there is a failure of the cloud stitching process 098, the process will return to the main data management application user interface 096. If the cloud stitching process 098 is successful, the disaster recovery/backup process 103A will be accessed (instead of the resource manager 100, the synchronization process 102, or another signal manipulation process understood by someone skilled in the art 101). Once the disaster recovery/backup process 103A is accessed, the database 105 will be downloaded 103B. The download of the database 105 is analyzed 106 and if unsuccessful, the process will return to the main data management application user interface 096. If the database download is successful, a list of files is created 107 and the storage location on the PCD is confirmed 108. Next, the list is executed with the most current version of the file 109 and the list is sent to the database 105, prior to checking the PCD capacity and the size of the data 111. An analysis is also done to determine if the recovered list is complete 112. If the list is not complete, the database 105 and logs 104 are updated 110, and the list is re-executed with the most recent versions of the files 109. If the recovered list is complete, the user returns to the main data management application user interface 096. Next, the device capacity is analyzed against the file size 113, and if there is not enough space on the PCD, a link to the SSD is created to replace the data object 114. Once the link is created, the list of files is checked to determine if it is complete 112. If it is not complete, the database 105 and logs 104 are updated 110, and the most current file list is executed 109 again. If the list is complete, the user returns to the main data management application user interface 096. If the device capacity is analyzed against the file size 113, and found to have enough space, the resource manager 115 is accessed. The synchronization process 120, the disaster recovery/backup process 118, or another signal manipulation process understood by someone skilled in the art 116, are not accessed at this stage. The resource manager 115 is then tasked with determining the success of the data recovery 123. If it is unsuccessful, the user returns to the main data management application user interface 096, and the logs 104 are updated 119. If the data recovery is successful, the database 105 and logs 104 are updated 117. Next, an analysis is done to determine if the recovered list is complete 121. If the list is not complete, the list is re-executed with the most recent versions of the files 109. If the recovered list is complete, the database 105 and logs 104 are updated 122, and the user returns to the main data management application user interface 096.

In embodiments of FIG. 6, the representation consists of cloud storage devices. This figure illustrates the use of multiple cloud storage spaces as a seamless storage environment. In one embodiment, the main data management application user interface 133 will send a cloud storage request 127. An authentication procedure 126 is undertaken to determine if the cloud storage space provider has registered the user as a user of their own service. If the authentication is granted, a request broker will 125 will determine through a cache 124, the available cloud storage space 137, 138, 136 and return the result to the cloud storage request 127. The database 128 may gain access the request broker 125 and the cache 124, and eventually the cloud storage space 137, 138, 136. If the authentication is not granted, a request for authentication will be made to the cloud storage spaces 129, 130, of any number 131. If any of the cloud authentications 129, 130, 131 are not successful, the user is returned to the main data management application user interface 133. If any the cloud authentications 129, 130, 131 are successful, they will make a connection to the cloud storage spaces 132, 135, of any number 134. The cloud storage spaces 137, 138, 136 will be made available, and the cloud request 127 is fulfilled through the cache 124 and request broker 125.

In embodiments of FIG. 7, the process ensures that in the event of a personal computing device failure, and the loss of user data, the data management application can retrieve all the data from the secondary storage device and ensure that no user data is lost. In one embodiment, the main data management application user interface 142 provides access to the resource manager 140, the synchronization process 141, the disaster recovery/backup process 143, or another signal manipulation process understood by someone skilled in the art 144. When the disaster recovery/backup process 143 is selected, it will access the database 145 and create a list of the files to backup 146. Next, the file modification time is selected from the PCD and the SSD 148 before an analysis is performed on the file to determine if the file is of a more recent version (or present at all) on the SSD, or on the PCD 149 using UTC. If the file is found to be more recent on the SSD, the disaster recovery/backup process 153 will be reengaged, and the file will be downloaded from the SSD 159 before the logs 139 and database 145 are updated 160. The resource manager 151, the synchronization process 152, or another signal manipulation process understood by someone skilled in the art 156, are not accessed during this process. If the file is found to be more recent on the PCD or not present on the SSD at all, the file will be copied to the SSD 150, prior to the disaster recovery/backup process 157 reengaging. The resource manager 154, the synchronization process 155, or another signal manipulation process understood by someone skilled in the art 158, are not accessed during this process. The logs 139 and database 145 will be updated 160 at this time. Throughout the recovery process, the cloud stitching process 147 can be used to provide storage space and can be accessed when the file modification time is selected 148, or through the resource manager 151, 154 during the last part of the recovery process. Once the logs and database have been updated 160, an analysis is performed to determine if the file list is complete 161. If the list is found to be complete, the user is returned to the main data management application user interface 142. If the list is found to be incomplete, the system will proceed to obtain the next file 162 by returning to the file selection step 148.

In one embodiment of the contemplated system and method, it is understood that user implemented action, such as but not limited to data migration, may initiate an advertisement on the PCD, for the purposes of commercialization.

It is contemplated that the system and method as described may be available to a user free of charge. It is further contemplated that particular aspects of the disclosure as described will not be immediately available to a user. It is understood that a specific or multiple features of the data management application may be withheld from a free version of the data management application, and will only be available to a user upon receipt of payment. For example, it is conceivable that the data encryption option as described above would only be available after a user has made payment.

The invention as contemplated will now be described with reference to specific examples. It will be understood that the following examples are intended to describe embodiments of the invention and are not intended to limit the invention in any way.

### EXAMPLES

In one example, a user may download the data management application onto their mobile phone from an online application provider. When the data management application is opened, a message will prompt the user to make selections regarding data migration or to accept the default settings as defined by the invention. The user selects to set a threshold that prevents the initiation of data migration until there are 10 GB or less of storage space available on their mobile phone. Forty-one days later the user reaches the threshold PCD limit they defined earlier. The data management application is initiated and begins data migration to a cloud storage space over the user's mobile network. Application icons are disassociated from their data object and left for the user to view on their mobile phone, the data migration is commenced, and the transfer eventually completed after 19 minutes. The disclosure confirms a successful data migration. Nine days later, the user decides to open an application that had previously been migrated and selects the application icon on their mobile phone. The data management application initiates again and using the WiFi network in the user's home, re-associates the application icon with its respective data object, and migrates the application data back to the user's phone. After a minute, the user is able to access the application on their mobile device.

In another example considering the scenario as described above, the user decides to download the data management application onto their tablet instead of a mobile phone. It is also contemplated that the user may download the system and method onto both their tablet and mobile phone, or a combination of PCD's as would be understood by someone skilled in the art.

In another example considering the scenario as described above, the user elects to use default settings as defined by the invention. Four days after initial data management application download, the user accesses the system and method, and then decides to make manual selections regarding data migration instead of using the default settings.

In another example considering the scenario as described above, the data management application is set to run on a daily basis. One day after the user downloads the system and method; it is initiated and performs data migration. A day later it is initiated again, checks the existing SSD to see if there is any updated data on the PCD that has not been migrated, and performs migration of any new data.

In another example considering the scenario as described above, the user selects to set a threshold that prevents the initiation of data migration until the user is in a WiFi zone. When the data management application is initiated and attempts data migration over the user's mobile network, migration is prevented and the invention returns a message to the user of a failed data migration.

In another example considering the scenario as described above, the user selects a threshold of at least 40% battery life in order for a data migration to initiate. The user has been away from a charging source for 2 days and their mobile phone has 16% charge remaining. Data migration will not initiate as the PCD has exceeded the user defined battery level threshold, and a transfer failure message is sent to the user.

In another example considering the scenario as described above, the user selects a time limit threshold of 15 minutes to complete a data migration. The initial migration is not completed within that time limit threshold and is therefore stopped. A failure to migrate data due to exceeding a transfer time limit message is returned to the user.

In another example considering the scenario as described above, 4 months after the initial data migration the user's mobile phone capacity drops below 10 GB availability again. The data management application initiates and attempts to migrate new data found on the phone that is not already migrated. The migration is prevented due to a lack of storage capacity available on the cloud storage space—the available room on the cloud was not enough to accommodate the migrated data from the user's phone. The user is informed of the migration failure and the lack of available storage capacity on the SSD.

In another example considering the scenario as described above, when the data management disclosure attempts to reintroduce the migrated user application, it finds that the storage capacity of the user's mobile phone will not accommodate reintroduction of the user application. An SSD link to the user application is provided and a failure to migrate due to lack of PCD storage capacity message is returned to the user.

In another example considering the scenario as described above, when the user is undertaking an initial data migration, the user's mobile network crashes. The data migration process is interrupted and tagged as incomplete. A message is sent to the user informing them of a failure to migrate data. Two hours later the user's mobile network comes back online. When the data management application reinitiates it automatically recognizes the tagged incomplete data migration, and returns to completing the migration. Ten minutes later the migration is completed and the user received a successful migration message.

In another example considering the scenario as described above, the user decides to delete the data management application. One year later the user re-downloads the data management application and is identified as having previously used the system. The user is re-associated with the previous cloud storage space they had migrated data to in the past. They are able to access this old data and may decide to update data migration from their mobile phone.

In another example considering the scenario as described above, the user loses their mobile phone after migrating the data. They decide to buy a new mobile phone and download the data management application from an application provider. After the download is completed, the user selects to install the data management application in disaster event mode. After the user selects this installation, all data saved on the cloud storage space will be reintroduced to the new mobile phone restoring the data that was lost with the original phone.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Various embodiments of the present invention utilize real and/or virtual computer resources. Such computer resources utilize, at a hardware level, a set of one or more microprocessors operatively coupled to a corresponding set of memory components which include stored program instructions for execution by the microprocessors. Computing resources may be used to provide virtual computing resources at one or more levels of virtualization. For example, one or more given generic computer hardware platforms may be used to provide one or more virtual computing machines. Computer hardware, such as processor resources, memory, and the like, may also be virtualized in order to provide resources from which further virtual computing machines are built. A set of computing resources which are allocatable for providing various computing resources which in turn are used to realize various computing components of a system, may be regarded as providing a distributed computing system, the internal architecture of which may be configured in various ways.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

It is obvious that the foregoing embodiments of the present invention are examples and can be varied in many ways. Such present or future variations are not to be regarded as a departure from the spirit and scope of the disclosure, and all such modifications as would be obvious to one skilled in the art are intended to be included within the scope of the following claims.

The scope of the claims should not be limited by the preferred embodiments set forth in the examples, but should be given the broadest interpretation consistent with the description as a whole.

We claim:

1. A system for data consolidation and management for use with at least one personal computing device, the system comprising:
a user interface configured to connect the at least one personal computing device to an interface module;
an interface module configured to connect a user interface to a management module;
a management module configured to connect the interface module with at least one secondary storage device; and
secondary storage configured to provide storage capacity for the storage of data from the at least one personal computing device.

2. The data consolidation and management system according to claim 1, wherein the at least one personal computing device uses at least one application further comprising:
an at least one display component that provides a user means to access processing functions of the at least one application; and
an at least one processing function that is comprised of at least one data object.

3. The data consolidation and management system according to claim 1, wherein a user interface provides means for at least one user of the at least one personal computing device to make at least one selection regarding data consolidation and management.

4. The data consolidation and management system, wherein an interface module provides means for disassociating and/or re-associating the at least one display component from the at least one data object according to claim 2.

5. The data consolidation and management system, wherein management software provides means for consolidating and managing at least one data object, within a personal computing device or secondary storage device, in response to the at least one selection according to claim 3.

6. The data consolidation and management system, wherein the at least one secondary storage device provides means for storing the at least one data object according to claim 4.

7. The data consolidation and management system, wherein means for consolidating and managing at least one data object according to claim 5 provide migration of the at least one data object from the at least one personal computing device to the at least one secondary storage device, or from the at least one secondary storage device to the at least one personal computing device.

8. A method for data consolidation and management for use with at least one personal computing device, the method comprising:
input from a user to a user interface configured to connect the at least one personal computing device to an interface module;
an action performed by a interface module in response to the user input, which is configured to connect a user interface to a management module;
an action performed by a management module in response to the interface module, which is configured to connect the interface module with at least one secondary storage device; and
an action performed by at least one secondary storage device in response to the management module, which is configured to provide storage capacity for the storage of data from the at least one personal computing device.

9. The method for data consolidation and management according to claim 8, wherein the action performed by at least one secondary storage device is completed after the at least one secondary storage device has be associated with at least one other secondary storage device.

10. The method for data consolidation and management according to claim 9, wherein the at least one secondary storage device is associated with at least one other secondary storage device, which consists of an online cloud storage space.

11. A computer program product comprising a computer readable memory storing computer executable instructions thereon that when executed by a computer perform the method steps of claim 8.
